(19) United States
(12) Patent Application Publication
(10) Pub. No.: US 2011/0197756 A1
(43) Pub. Date: Aug. 18, 2011

(54) Wiper Arrangement and Compressor with such a Wiper Arrangement

(75) Inventors: Christian Hold, Bisamberg (AT); Tino Lindner-Silwester, Wien (AT); Martin Lagler, Wien (AT)

(73) Assignee: HOERBIGER KOMPRESSORTECHNIK HOLDING GMBH

(21) Appl. No.: 13/027,774

(22) Filed: Feb. 15, 2011

(30) Foreign Application Priority Data
Feb. 15, 2010 (AT) A 216/2010

(51) Int. Cl. F16J 15/16

(52) U.S. Cl. 92/165 R; 277/553

(57) ABSTRACT

Conventional wiper arrangements with cut rings suffer from unavoidable leakage and, in particular in an embodiment as metallic wiper ring with a sharp wiping edge, scratch on the surface of the piston rod which can be damaged in this manner. In order to eliminate these problems, a wiper arrangement is proposed in which the radially inner circumferential surfaces 6, 7 of the wiper ring 2 and the cover ring 3 form a common radially inner wiping surface 10 and on the cover ring 3 or the on the wiper ring 2, an intake surface 8 is provided which is adjacent to the wiping surface 10 and which is inclined radially outwardly at an angle α, preferably between 2° and 15°, with respect to the wiping surface 10.

The present invention relates to a wiper arrangement with a wiper ring which is split in the circumferential direction and an L-shaped cover ring which is split in the circumferential direction, wherein the splitting points of the cover ring and the wiper ring are arranged offset to each other in the circumferential direction and the wiper ring is arranged abutting axially as well as radially in the recess of the L-shaped cover ring, and to a compressor with such a wiper arrangement.

Usually, the crankcase of piston compressors contains oil for lubricating the moving parts of the piston compressor. The oil also gets onto the piston rod and could be transported along the piston rod into the compression chamber which is undesirable because this represents a significant oil leakage and the oil is also partially discharged with the compression medium. For this purpose, usually, so-called wiper rings are provided in a wiper bush in the region of the piston rod, which wiper rings have to wipe off the oil film on the piston rod. The wiped-off oil is then appropriately discharged or recycled.

Also provided in piston compressors are sealing devices, usually a sealing ring or a sealing ring combination in a chamber of the chamber disk to seal the space with high pressure (cylinder) with respect to a space with low pressure (crankcase).

Previously known wiper rings are often metallic, radially cut rings with a sharp wiping edge which encloses and contacts the piston rod in the circumferential direction. Such cut wiper rings are held together by a circumferential spring and are activated by the same, i.e. for a proper function of the wiper ring, the radial contact pressure of the circumferential spring is necessary. In order to seal the radial cuts, often two radially cut rings are arranged offset to each other. Also known are arrangements consisting of one radially and one tangentially cut wiper ring. However, despite the offset arrangement of the rings, there is a leakage path along the outer circumferential surface of the rings because the radial joints are not hermetically sealed. There is also a significant leakage path on the inner circumferential surface of the rings because the wiper rings are profiled radially on the inside for forming a wiping edge. Thereby, oil leaks through the radial gap of the first ring which oil is directed along the inner circumferential surface (which, next to the wiping edge, does not abut against the piston rod) to the radial gap of the next ring and escapes there. Thus, the radial joints are sealed in the axial direction by the offset arrangement; however, there is still a leakage path from a radial joint of a first wiper ring to the radial joint of the adjacent wiper ring via the outer and inner circumferential surface of the adjacent wiper rings. The same problem can substantially occur in case of a combination of radially and tangentially cut wiper rings. Consequently, no matter how good the wiping edge of such a conventional arrangement is and how much oil it wipes off, there will always be a leakage path through which the oil can pass.

A similar problem occurs in sealing arrangements because such sealing arrangements have to be gas-tight to be able to develop a sealing effect so that leakage paths through the sealing arrangement can be prevented.

Another problem of metallic wiper rigs is that the sharp wiping edge scratches on the piston rod and can damage the same. Therefore, the wiping edge has to be manufactured with very exact, manufacturing tolerances to prevent excessive damage to the piston rod. However, this increases the manufacturing costs of conventional metallic wiper rings.

Wiper rings also need axial play in the wiper bush to prevent a jamming of the wiper rings in the wiper bush which can result in a high leakage. However, due to the axial play, with each stroke, a radial gap is opened between the axial inner side of the wiper bush and the wiper ring's front side facing the axial inner side, through which gap, oil can freely penetrate into the wiper bush and the necessary quick discharge of the oil from the wiper bush is difficult. For this purpose, it has already been provided in EP 1 061 295 A1 to use a throttle ring which, due to the acting oil adhesion, adheres on the axial inner side of the wiper bush and thus reduces the penetration of oil into the wiper bush. However, said wiper arrangement still uses the conventional, metallic, radially cut wiper rings with a sharp wiping edge and with all problems associated thereto and the above described problems. A further problem of this arrangement is that the radial thickness of the wiper rings has to be as small as possible for a better adaptation to the piston rod. However, the result of this is that during assembly, the wiper rings can be threaded onto the piston rods only with difficulties because the wiper rings fall radially into the wiper bush and thus, the axial bores and the piston rod are not coaxially anymore (not even approximately). Furthermore, in case of such an arrangement, a leakage path along the circumferential surface of the wiper ring can form because the radial joints are not hermetically sealed.

Another known wiper arrangement according to U.S. Pat. No. 6,959,930 B2 provides two wiper rings and one sealing ring which are arranged axially one behind the other within a wiper bush. The central wiper ring and the sealing ring form a conventional, radially and tangentially cut sealing ring pair for forming a sealing along a piston rod.

The central wiper ring thus combines the function of a wiper ring and a sealing ring in one ring. The central wiper ring is V-shaped on the outer circumferential surface, wherein in the indentation created in this manner, a circumferential spring is arranged which forces the wiper and sealing arrangement apart in the axial direction and thus pushes it against the inner sides of the wiper bush. Thus, the first wiper ring functions again as throttle ring which has to prevent an excessive penetration of oil into the wiper bush. Also, in this manner it is intended to ensure that the central wiper ring and the sealing ring are firmly pressed against each other also in the axial direction for forming a sealing. However, also in such an arrangement, the problem of the sharp wiper edges and the formation of a leakage path along the outer and inner circumferential surface of the rings still remains.

Wiper rings are often split in any way in order to allow a wear adjustment to be able to compensate an occurring thermal expansion, to be able to allow a simple assembly on the piston rod, and to be able to ensure a uniform wiping effect along the circumference of the piston rod. However, by splitting the wiper ring, there is always the risk of the formation of a leakage path, primarily along the outer and inner circumferential surface of the wiper ring, as explained above.

There are also non-cut wiper rings. However, these rings always suffer from the problems not to be able to adjust the wear or only to a limited extent and not to be able to sufficiently compensate thermal expansions due to different thermal expansion coefficients of piston rod and wiper ring.

Known are also piston ring arrangements from metallic, L-shaped cover rings into which sealing rings made of metal or plastic are inserted. Such a piston ring arrangement with cover and sealing rings split in the circumferential direction can be derived, e.g., from U.S. Pat. No. 1,822,101 A. Such arrangements seal radially on the outside with respect to a cylinder wall. In the piston ring arrangement shown therein, openings are provided in the rings to discharge excessive oil during the compression stroke through said openings from the compression chamber into the crankcase. However, this means that there is always oil in the compression chamber which in many cases is not desired because the compression medium can absorb the oil and transport it away. Similar piston ring arrangements can also be derived from U.S. Pat. No. 3,632,121 A and DE 2 323 455 A. Such piston ring arrangements have in common that in each case the L-shaped ring, independently of the ring arranged therein, can lift off from the sealing surface (here the cylinder wall), whereby a wiping edge can be formed which, from the point of view of a minimum leakage, can be undesirable. A further problem of such piston rod arrangements is that the rings form a distinct wiping edge on both sides of the arrangement, whereby the oil which has passed through the piston ring arrangement during a stroke of the piston and has not been wiped off is partially wiped off in each case during the following stroke in the opposite direction and thus an undesired leakage along the cylinder wall can occur.

It is now the object of the present invention to provide a wiper arrangement with a cut wiper ring and a compressor with such a wiper arrangement wherein the effects of the aforementioned problems are reduced thus, in particular, to prevent the formation of a leakage path through the wiper arrangement, to reduce the risk of damage to the surface of the piston rod caused by the scratching of the wiper arrangement and to reduce the leakage along the piston rod.

This object is solved according to the invention by a wiper arrangement with a wiper ring which is split in the circumferential direction and an L-shaped cover ring split in the circumferential direction, wherein the splitting points of the cover ring and the wiper ring are arranged offset to each other in the circumferential direction and the wiper ring is arranged abutting axially as well as radially in the recess of the L-shaped cover ring and the radially inner circumferential surfaces of the wiper ring and the cover ring form a common radially inner wiping surface. Due to the splitting points offset in the circumferential direction and due to the wiper ring abutting in the recess of the cover ring, the wiper arrangement is axially sealed. Due to the fact that the cover ring and the wiper ring form a common wiping surface, no leakage path can form along the inner circumferential surface of the wiper ring or the cover ring because the wiper arrangement abuts against the piston rod and the wiper ring abuts over the entire height against the cover ring. Thus, the wiper arrangement according to the invention effectively reduces undesired leakage. At the same time, the wiping surface provides that the surface of the piston rod is not being damaged by the wiper arrangement. Due to the intake surface which is provided on the cover ring or the wiper ring and is adjacent to the wiping surface and which is inclined radially outwardly at an angle, preferably between 2° and 15°, with respect to the wiping surface, advantageously, a suction effect can be generated which, during the suction stroke of the piston rod subsequent to the wiping stroke, takes in the oil again that has passed through the wiper arrangement and has not been wiped off, whereby the wiping effect can be improved and the leakage along the piston rod is reduced.

Advantageously, on the wiper ring, an entrance surface is provided which is adjacent to the wiping surface and which is inclined radially outwardly at an angle, preferably between 40° and 90°, preferred between 50° and 80°, with respect to the wiping surface. In this region, a sufficient oil film for lubricating the wiper arrangement for reducing the wear as well as a good wiping effect of the wiper arrangement can be achieved.

If the axial contact surface between wiper ring and cover ring is inclined with respect to a vertical to the wiping surface so that the wiper ring is retained in a positive-locking manner in the radial direction in the recess, it is ensured that the intake effect of the intake surface is maintained and thus the leakage is reduced.

In order to implement a radial interlock which has to prevent the wiper arrangement from falling into the wiper bush, preferably, an axially projecting nose is provided on the cover ring and an axial projection adjacent to the entrance surface is provided on the wiper ring, wherein the inner diameter of the axial projection is larger than the outer diameter of the nose. In this manner, the mounting of the piston rod, which is pushed through the wiper arrangement, can be simplified because the wiper arrangement remains largely concentric to the piston rod.

Advantageously, with an wiper arrangement according to the invention, a sealing effect can be achieved at the same time if on the cover ring, an entrance surface is provided which is adjacent to the wiper surface and which is inclined radially outwardly at an angle, preferably between 40° and 90°, preferred between 50° and 80°, with respect to the wiping surface. Such a wiper arrangement can be combined particularly well with another wiper arrangement in a chamber so that towards the crankcase, a wiping effect and towards the cylinder space, a sealing effect can be achieved. In such an arrangement, in turn, it is advantageous to incline the contact surface between wiper ring and cover ring with respect to a vertical to the wiping surface so that the cover ring is retained in a positive-locking manner on the wiper ring, whereby it is ensured again that the cover ring follows a possible lift-off movement of the wiper ring. For implementing a radial interlock, an axially projecting nose can be provided on the cover ring and an axial recess can be provided on the front side of the wiper ring, wherein in the case of wiper arrangements abutting axially against each other, the nose engages with the recess.

If the nose is arranged on an axial projection, a radially freely penetratable region is created which prevents that oil is locked in between two adjacent wiper arrangements.

If in the wiper bush, a pretensioning ring is arranged which axially abuts via a spring against a first axial boundary surface and the adjacent wiper arrangement, the formation of a radial gap at the entrance to the wiper bush and thus a high leakage through said gap can be prevented. The same applies substantially if the pretensioning element is arranged axially between two wiper arrangements.

The wiper arrangement according to the invention can particularly advantageously be used for implementing a wiping effect as well as a sealing effect, wherein only the orientation of the wiper ring of the wiper arrangement has to be considered. For achieving a wiping effect, the wiper ring has to face the oil-conveying side while for achieving a sealing effect, the wiper ring has to face the side with the higher pressure.

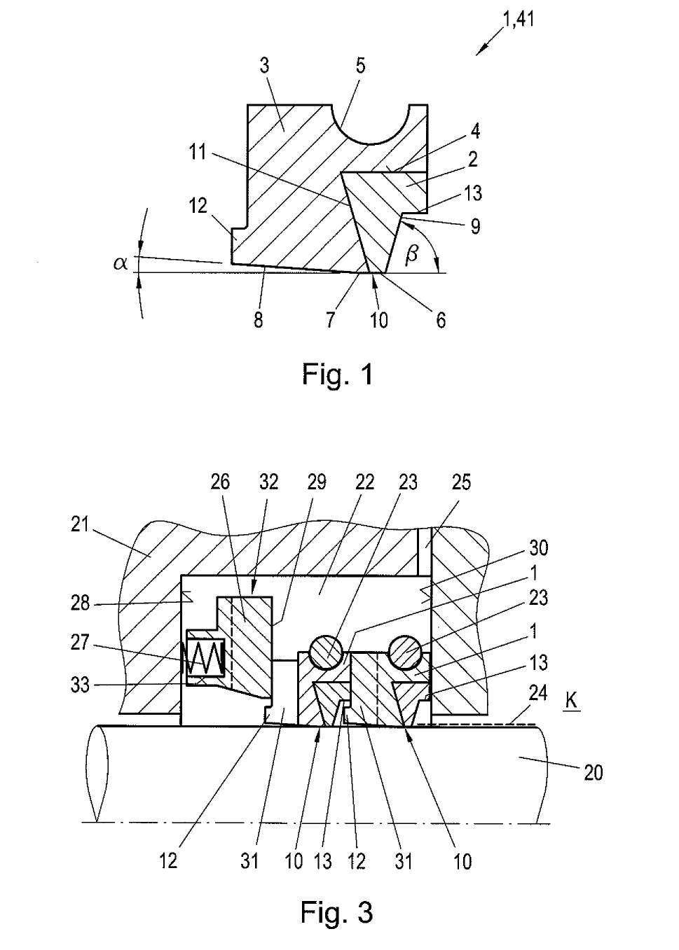

The present invention is illustrated with reference to the schematic FIGS. 1 to 7 showing exemplary, preferred configurations. In the figures:

FIG. 1 shows a section through a wiper arrangement according to the invention,

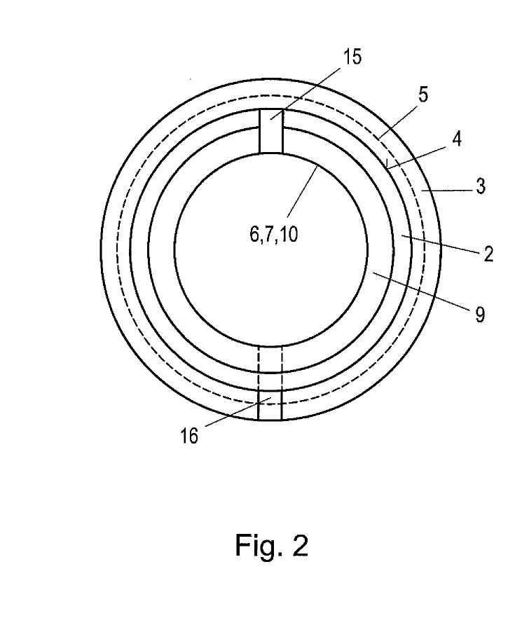

FIG. 2 shows a side view of a wiper arrangement according to the invention,

FIG. 3 shows a use of wiper arrangement according to the invention in a compressor,

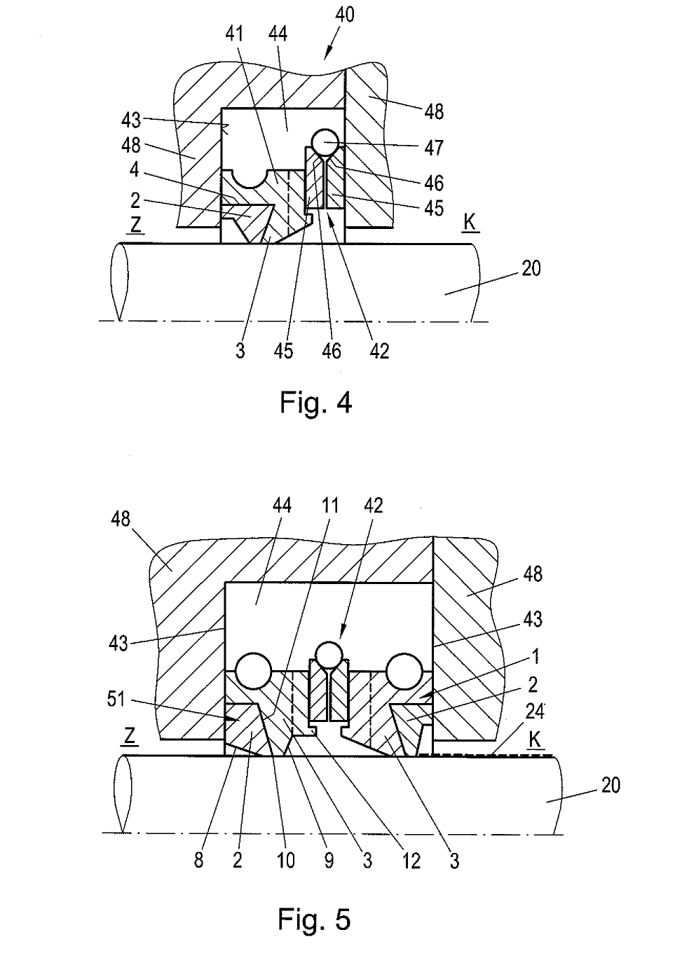

FIG. 4 shows a use of a wiper arrangement according to the invention as sealing arrangement in a sealing device of a compressor,

FIG. 5 shows a use of wiper arrangements according to the invention in a chamber for implementing a wiping and sealing effect,

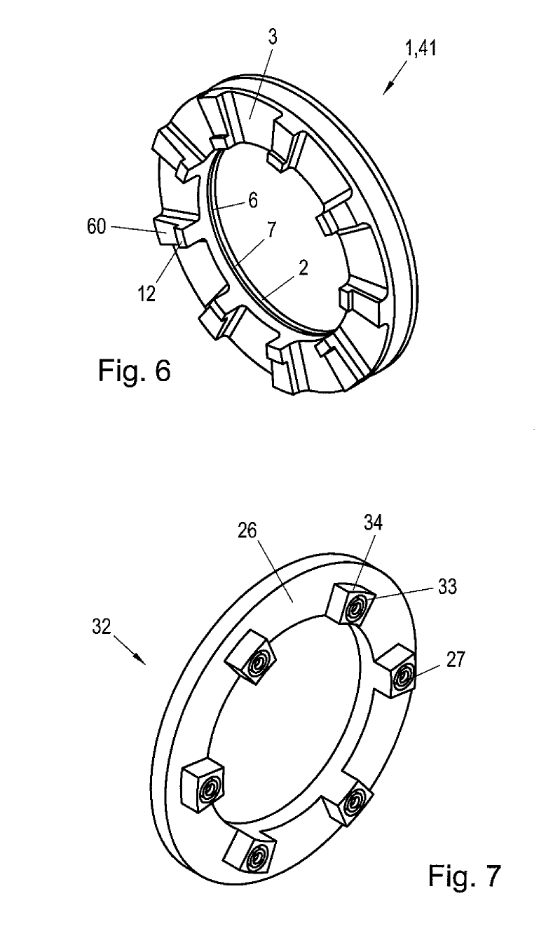

FIG. 6 shows a perspective view of the wiper arrangement according to the invention, and

FIG. 7 shows a perspective view of a pretensioning element.

A wiper arrangement 1 according to the invention is illustrated in an advantageous configuration in FIGS. 1, 2 and 6. Said wiper arrangement 1 consists of wiper ring 2 which is split in the circumferential direction and an L-shaped cover ring 3 which is split in the circumferential direction. Wiper ring 2 and cover ring 3 are advantageously radially cut at one or more points and are preferably made of a plastic and optionally of different materials or plastics. The radial gap 15 in the circumferential direction in the wiper ring 2 and the radial gap 16 in the circumferential direction in the cover ring 3 as illustrated in FIG. 2 are arranged offset to each other in the circumferential direction (here by 180°). However, the split in the circumferential direction can also be also be configured in a different manner such as, e.g. tangentially or in the form of a lock. In the cover ring 3, a recess 5 for receiving a circumferential spring is provided on the radially outer circumferential surface.

The wiper ring 2 is arranged in the recess 4 of the L-shaped cover ring 3 so that the wiper ring 2 abuts axially as well as radially against the inner surfaces of the recess 4. The radially inner circumferential surface 6 of the wiper ring 2 and the radially inner circumferential surface 7 of the cover ring 3 form a common wiping surface 10 which, in the operational use, abuts against the piston rod. Or, in other words, the axial contact surface 11 between wiper ring 2 and cover ring 3 separates the wiping surface 10 into two partial surfaces 6, 7. Thus, the wiper arrangement 1 according to the invention has no sharp wiping edge like conventional wiper rings, but has a wiping surface 10, whereby the wiper arrangement has a larger contact surface and the scratching on the piston rod surface is reduced. The wiping surface 10 is preferably dimensioned with a width between 0.5 and 1.5 mm. In the intended use as wiper arrangement 1, the wiper ring 2 always faces the oil-wetted side of the piston rod.

However, this arrangement has another crucial function. Because the wiper ring 2 abuts radially as well as axially over the entire circumference (excluding gap 15) against the full surface within the recess 4 and because the inner circumferential surface 7 of the cover ring 3 forms a part of the wiping surface 10, no leakage path through the wiper arrangement 1 can form. The gap 15 in the wiper ring 2 is completely covered by the cover ring 3, axially and radially, over the entire height of the wiper ring 2.

Therefore, this wiper arrangement 1 is even gas-tight and can also be used as sealing arrangement if the wiper ring 2 abutting in the recess 4 is arranged facing the space with high pressure to be sealed, as it is illustrated with reference to the FIGS. 4 and 5 in more detail hereinafter by means of concrete exemplary embodiments.

On the wiper ring 2, an entrance surface 9 is provided which is adjacent to the wiper surface 10 and, in sections, forms the front side of the wiper ring 2. The entrance surface 9 is inclined radially outwardly at an angle β with respect to the wiping surface 10. The angle β° lies preferably between 40° and 90°, particularly advantageously between 50° and 80°, so as to obtain an inclination of the entrance surface 9 as steep as possible because it was found that the wiping effect is better in case of a steep inclination of the entrance surface 9. For this purpose, the angle β is set as compromise between the desire of a wiping effect as good as possible (i.e. angle as steep as possible) and the desire to maintain a sufficiently thick oil film on the piston rod (i.e. providing a shallower angle) so as to ensure that the wiper arrangement 1 runs on an oil film and does not wear out. Said compromise can be achieved within the aforementioned range of the angle β. In the region of the gap 15 in the wiper ring 2, the cover ring 3 assumes the function of the entrance surface.

On the cover ring 3, an intake surface 8 is provided which is adjacent to the wiping surface 10 and forms, in sections, the front surface of the cover ring 3, and is inclined radially outwardly at an angle α with respect to the wiping surface 10. The angle α is preferably between 2° and 15° to obtain an inclination of the intake surface 8 as flat as possible. By the flat intake surface 8 is achieved that the oil which adheres on the piston rod during the suction stroke subsequent to the wiping stroke and which is not wiped off by the wiper arrangement 1 is taken in again during the following suction stroke so that the permanently present leakage along the piston rod is reduced.

Wiping stroke is to be understood here as the movement of the piston rod 20 during which oil is wiped off the piston rod 20, while suction stroke is to be understood as the movement of the piston rod 20 in the opposite direction.

The contact surface 11 between wiper ring 2 and cover ring 3 is advantageously inclined at an angle with respect to a vertical to the wiping surface 10 so that the wiper ring 2 is retained in a positive-locking manner in the recess 4 or in the cover ring 3. The axial boundary surface in the recess 4 in the cover ring 3 is formed in an adequately complementary manner. Due to the oil-wetted piston rod (wiping effect not 100%, desired lubrication by oil film), the cover ring 3 is slightly lifted during the suction stroke due to the flat intake surface 8. Because of the positive-locking attachment of the wiper ring 2 in the cover ring 3, thus, the wiper ring 2 is lifted at the same time and the oil can effectively be taken in. If the wiper ring 2 would not be lifted as this is the case, e.g. for a cut of 90° to the piston rod or an inclination in the opposite direction, the wiper ring 2 would form a wiping edge during the suction stroke which would not allow the intake of the oil.

Furthermore, an axially projecting nose 12 is provided on a front surface at the radially inner region on the cover ring 3. On the wiper ring 2, an axial projection 13 is provided on a front surface adjacent to the entrance surface 9, which axial projection has an inner diameter larger than the outer diameter of the nose 12 and interacts with the nose 12 of an adjacent wiper arrangement 1 as illustrated hereinafter.

In FIG. 3, a part of a compressor with a reciprocating piston rod 20 is illustrated. In a part of the compressor housing 21 or in a well-known chamber disk, a wiper bush 22 is provided in which at least one wiper arrangement 1 according to the invention is arranged. In the illustrated configuration, two wiper arrangements 1 are arranged axially one behind the other and axially abutting against each other. The wiper arrangements 1 abut in each case with their wiping surface 10 against the piston rod 20. The wiper arrangements 1 are each activated by a circumferential spring 23. To compensate axial play of the wiper arrangements 1 in the wiper bush 22, a pretensioning element 32 is provided, here in the form of a pretensioning ring 26, which abuts axially via a spring 27 (or a plurality of springs 27 distributed over the circumference) arranged in a recess 33 against the first axial boundary surface 28 of the wiper bush 22 and via its front surface 29 facing the wiper arrangement 1 against the wiper arrangement 1. Via the pretension of the spring, the wiper arrangements 1 are pressed against the second axial boundary surface 30 and thus seal radially. Therefore, no oil between wiper bush 22 and second boundary surface 30 can get into the wiper bush 22.

The axial recesses 33 for receiving the spring 27 at the pretensioning ring 26 can also be provided in axial projections 34 to create a region which is radially freely penetratable, as illustrated in FIG. 6, so as to prevent that oil is locked in between pretensioning ring 26 and piston ring 20 but can get via said freely penetratable region into the wiper bush 22 from where it can be discharged through the discharge openings 25. Likewise, the noses 12 can be arranged on axial projections 60 on the cover ring 3 to create a region which is radially freely penetratable, as illustrated in FIG. 5, so as to prevent that oil is locked in between two adjacent wiper arrangements 1 or between wiper arrangement and pretensioning element 32 but can get via said freely penetratable region into the wiper bush 22 from where it can be discharged through the discharge openings 25.

However, any other pretensioning element 32, 42 suitable for pushing the wiper arrangement 1 against the axial boundary surface 30 can also be used. For example, it is also possible to provide just one spring as pretensioning element 32, 42 in the compressor housing 21 or in a chamber disk forming the wiper bush 22, whereby a pretensioning ring 26 could even be eliminated.

The nose 12 and the projection 13 of the adjacent wiper arrangements 1 form a radial interlock which prevents the wiper arrangement 1 from falling radially into the wiper bush 22, which facilitates the mounting of the piston rod 20 which is pushed through the wiper arrangement 1. For this, the pretensioning ring 26 engages radially outside of the nose 12 with the adjacent wiper arrangement 1, whereby said wiper arrangement 1 is radially supported at the pretensioning ring 26 via the nose 12 and it is prevented that the wiper arrangement 1 facing the pretensioning ring 26 radially falls into the wiper bush 22 when the piston rod 20 is removed.

An oil film 24 on the piston rod 20 is wiped off by wiper arrangement 1 arranged at the entrance of the wiper bush 22. The oil which still passes through between wiper arrangement 1 and piston rod 20 and is not taken in by the intake effect is wiped off by the following wiper arrangement 1. In order to discharge the oil accumulating between the two wiper arrangements 1, one (or more, distributed over the circumference) radial recess 31 is provided at the front surface on the rear side of the cover ring 3 of a wiper arrangement 1 (as shown in FIG. 6), through which recess the oil gets into the wiper bush 22 from where it is discharged through a discharge opening 25.

Due to the gas-tightness of the wiper arrangement 1, the same can also be used in a sealing device 40 as sealing arrangement 41 for sealing the piston rod 20 (instead or additionally to a known sealing ring such as, e.g. a segmented sealing ring or a known sealing ring combination of, e.g., radially and tangentially cut rings). In such a sealing device 41 arranged in a chamber 44 of a chamber disk 48, as illustrated in FIG. 4, the sealing arrangement's 41 wiper ring 2 arranged in the recess 4 of the cover ring 3 would always be arranged facing towards the side to be sealed with the high pressure; thus, in case of a compressor, e.g. towards cylinder space Z. Also, in such a sealing device 40, a pretensioning element 42 can be provided which presses the sealing arrangement 41 against the axial boundary surface 43 of the chamber 44. Here, the pretensioning element 42 comprises two pretensioning rings 45 each with a chamfer 46 on the radially outer circumferential surface. The two pretensioning rings 45 are arranged axially adjacent with the two chamfers 46 facing each other. In the circumferential groove created by the two chamfers 46, an annular spring 47 is arranged which, due to the chamfers 46, forces the two pretensioning rings 45 apart and thus presses the sealing arrangement 41 against the boundary surface 43.

However, it is also possible to combine a wiper arrangement 1 and a sealing arrangement 51 within a chamber 44 or a wiper bush 22, as illustrated in FIG. 5, so as to seal in the direction towards the cylinder space Z (side with high pressure) as well as to provide a wiper arrangement in the direction towards the crankcase K. In the chamber 44 of a chamber disk 48, a wiper arrangement 1 is arranged on the side facing the crankcase, wherein the wiper arrangement removes the oil from the oil-wetted piston rod 20, as described above. At the chamber's 44 end Z on the cylinder side, a wiper arrangement 1 according to the invention is provided and used as sealing arrangement 51. Axially therebetween, again, a pretensioning element 42 is provided, as described above, which forces the sealing arrangement 51 and the wiper arrangement 1 axially apart and presses them against the axial boundary surfaces 43 of the chamber 44. Here, the entrance surface 9 is provided on the cover ring 3 and the intake surface 8 is provided on the wiper ring 2, wherein for generating the sealing effect, the wiper ring 2 is arranged facing the space with the high pressure, here, the cylinder space Z. The contact surface 11 between wiper ring 2 and cover ring 3 is inclined here with respect to a vertical to the wiping surface 10 in such a manner that the cover ring 3 is retained in the radial direction in a positive-locking manner and thereby follows the lifting movement of the wiper ring 2 of the piston rod 20, which lifting movement is caused by intaking oil at the intake surface 8 during the suction stroke. In this configuration, the sealing arrangement 41 implements a sealing effect towards the side with the high pressure and, at the same time, a wiping effect in the opposite direction. Of course, it is possible again to provide a plurality of sealing arrangements 51 or a plurality of wiper arrangements 1 arranged axially abutting against each other. In this case, an axial recess could be provided on the front side of the wiper ring 2 to form a radial interlock again with the nose 12 of the adjacent sealing arrangement 51 by the nose 12 axially engaging with the recess. However, said sealing arrangement 51 could also be used in an arrangement according to FIG. 4 instead of the sealing arrangement 41 shown therein.

Also, the wiper arrangement 1 could be used as sealing element in a sealing arrangement for sealing a reciprocating piston rod of a piston compressor as described in the Austrian patent application A39/2009, wherein in such a sealing arrangement, the wiper ring 2 of the wiper arrangement 1 would be arranged facing the space with the sealing medium (side with the high pressure).

Although the wiper arrangement 1 has been described only in connection with cut rings it has to be mentioned here that such a wiper arrangement 1 could also be implemented with non-cut rings.

1. A wiper arrangement with a wiper ring (2) which is split in a circumferential direction and an L-shaped cover ring (3) which is split in the circumferential direction, wherein splitting points (16, 15) of the cover ring (3) and the wiper ring (2) are arranged offset to each other in a circumferential direction and the wiper ring (2) is arranged abutting axially as well as radially in a recess of the L-shaped cover ring (3), wherein radially inner circumferential surfaces (6, 7) of the wiper ring (2) and the cover ring (3) form a common radially inner wiping surface (10), and including an intake surface (8) on the cover ring or the wiper ring which is adjacent to the wiping surface (10) and which is inclined at an angle (α), preferably between 2° and 15°, with respect to the wiping surface (10).

2. The wiper arrangement according to claim 1, including an entrance surface (9) on the wiper ring which is adjacent to the wiping surface (10) and which is inclined radially outwardly at an angle (β) between 40° and 90°, preferred between 50° and 80°, with respect to the wiping surface (10).

3. The wiper arrangement according to claim 1, wherein an axial contact surface (11) between wiper ring (2) and cover ring (3) is inclined with respect to a vertical to the wiping surface (10) so that the wiper ring (2) is retained in a positive-locking manner in the radial direction in the recess (4).

4. The wiper arrangement according to claim 2, including an axially projecting nose (12) on the cover ring and an axial projection (13) on the wiper ring adjacent to the entrance surface (9), wherein an inner diameter of the axial projection (13) is larger than an outer diameter of the nose (12).

5. The wiper arrangement according to claim 1, including an entrance surface (9) on the cover ring which is adjacent to the wiping surface (10) and which is inclined radially outwardly at an angle (β) between 40° and 90°, preferred between 50° and 80°, with respect to the wiping surface (10).

6. The wiper arrangement according to claim 5, wherein a contact surface (11) between wiper ring (2) and cover ring (3) is inclined with respect to a vertical to the wiping surface (10) so that the cover ring (2) is retained in a positive-locking manner in the radial direction on the wiper ring (2).

7. The wiper arrangement according to claim 5, including an axially projecting nose (12) on the cover ring and an axial recess is provided on a front side of the wiper ring, wherein in the case of axially abutting wiper arrangements, the nose (12) engages with the recess.

8. The wiper arrangement according to claim 7, wherein the nose (12) is arranged on an axial projection (60).

9. A compressor with a reciprocating piston rod (20) and a wiper bush (22) in a part of a compressor housing (21), said wiper bush including a wiper arrangement (1) according to claim 1 is arranged.

10. The compressor according to claim 9, wherein for implementing a wiping effect, the wiper ring (2) of the wiper arrangement (1) is arranged facing a oil-wetted side of the piston rod (20).

11. The compressor according to claim 9, wherein the wiper arrangement (1) is used as sealing arrangement (41, 51), wherein for implementing a sealing effect, the wiper ring (2) of the sealing arrangement (41, 51) is arranged facing a side with high pressure.

12. The compressor according to claim 9, wherein in the wiper bush (22), a plurality of wiper arrangements (1) or sealing arrangements (41, 51) axially abutting against each other is arranged.

13. The compressor according to claim 9, wherein the wiper bush (22) includes a pretensioning element (32, 42) which presses the wiper arrangement (1) or the sealing arrangement (41, 51) axially against an axial boundary surface (23, 43) of the wiper bush (22).

14. The compressor according to claim 10, including a chamber (44) containing a wiper arrangement (1) and a sealing arrangement (51), wherein axially between the wiper arrangement (1) and the sealing arrangement (51), a pretensioning element (42) is arranged which presses the wiper arrangement (1) and the sealing arrangement (51) against an axial boundary surface (43) of the chamber (44).
